(19) United States
(12) Patent Application Publication
(10) Pub. No.: US 2025/0141240 A1
(43) Pub. Date: May 1, 2025

(54) SYSTEM AND METHOD FOR BATTERY CELL BALANCING

(71) Applicant: Zitara Technologies, Inc., San Francisco, CA (US)

(72) Inventors: Daniel Foran, San Francisco, CA (US); Daniel Vickery, San Francisco, CA (US); Emily Zhang, San Francisco, CA (US); Derek Gutheil, San Francisco, CA (US); Mark Tobenkin, San Francisco, CA (US); Yumeng Gao, San Francisco, CA (US); Evan Murphy, San Francisco, CA (US)

(73) Assignee: Zitara Technologies, Inc., San Francisco, CA (US)

(21) Appl. No.: 18/933,906

(22) Filed: Oct. 31, 2024

Related U.S. Application Data
(60) Provisional application No. 63/594,889, filed on Oct. 31, 2023.

(51) Int. Cl. H02J 7/00; H01M 10/44

(52) U.S. Cl. CPC H02J 7/0016; H01M 10/441; H02J 7/0048

(57) ABSTRACT

A method can include modeling a state of each battery cell within a battery pack and contemporaneously with discharging a first subset of battery cells of the battery pack either providing a differential drain on the first subset of battery cells such that battery cells of the first subset of battery cells are discharged faster than a second subset of battery cells or charging the second subset of battery cells (e.g., using the first subset of battery cells) where battery cells are identified as in the first subset or the second subset based on the states of the battery cells.

### CROSS-REFERENCE TO RELATED APPLICATIONS

This application claims the benefit of U.S. Provisional Application No. 63/594,889 filed 31 Oct. 2023, which is incorporated in its entirety by this reference.

### TECHNICAL FIELD

This invention relates generally to the battery monitoring field, and more specifically to a new and useful system and method in the battery monitoring field.

### BRIEF DESCRIPTION OF THE FIGURES

FIG. 1 is a schematic representation of an example of a method.

FIG. 2 is a schematic representation of an example relationship between open circuit voltage and state of charge of a cell.

FIG. 3 is a schematic representation of an example of battery cell imbalance within a battery pack.

FIG. 4 is a schematic representation of an example of differences in temporal response time between variants of the method and variants of battery management systems detecting charge imbalance.

FIG. 5 is a schematic representation of an example of passive battery cell balancing.

FIG. 6 is a schematic representation of an exemplary system.

### DETAILED DESCRIPTION

The following description of the embodiments of the invention is not intended to limit the invention to these embodiments, but rather to enable any person skilled in the art to make and use this invention.

### 1. Overview

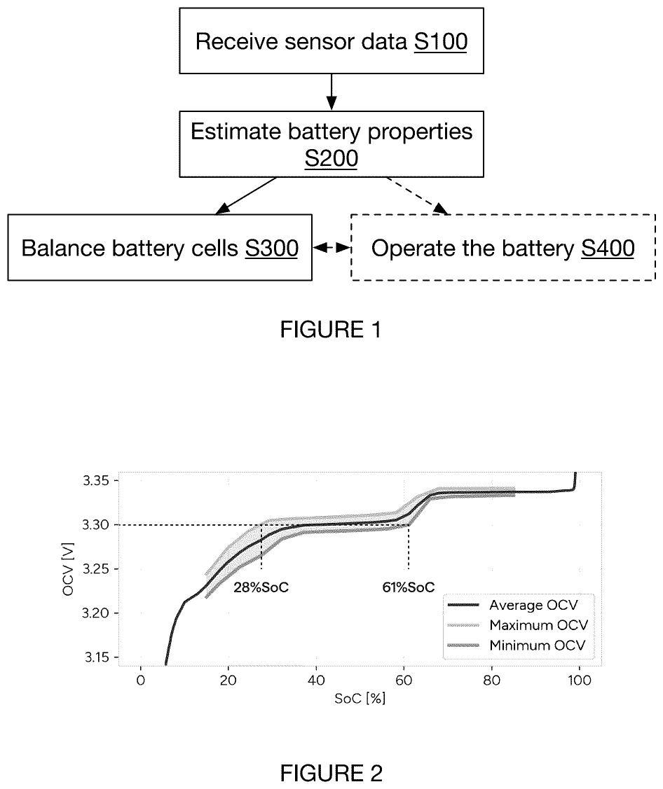

As shown in FIG. 1, the method can include receiving sensor measurement(s) S100, estimating battery property(s) S200, balancing battery cells S300, operating the battery pack S400, and/or any suitable steps. The method is preferably performed on a system that includes a battery pack (e.g., including two or more battery cells in series), one or more sensors, one or more computing systems, and/or any suitable system.

The method can function to optimize performance (e.g., improve, maximize, etc. observability of battery pack state(s); improve, maximize, etc. battery pack capacity; improve, maximize, etc. battery pack lifetime; minimize, decrease, etc. battery pack degradation; etc.) of a battery pack of a battery-operated system. Exemplary battery-operated systems included: grid energy storage, unmanned aerial vehicles (e.g., UAVs, drones, etc.), satellites, rovers, electric vehicles (e.g., electric cars, electric trucks, shipping vehicles, buses, trains, electric passenger vehicles, etc.), electric submarines, electric boats, user devices (e.g., smart phones, computers, power tools, yard tools, toys, etc.), electrical generators, consumer electronics, electric bicycles, scooters (e.g., electric scooters, electric motorbikes, etc.), mobility scooters, wheelchairs, personal transporters (e.g., kick scooters, electric skateboards, self-balancing unicycles, Segway, etc.), electric airplanes, construction equipment, and/or any suitable battery-operated or leveraging system. However, the method can perform any function.

### 2. Technical Advantages

Variants of the technology can confer one or more advantages over conventional technologies.

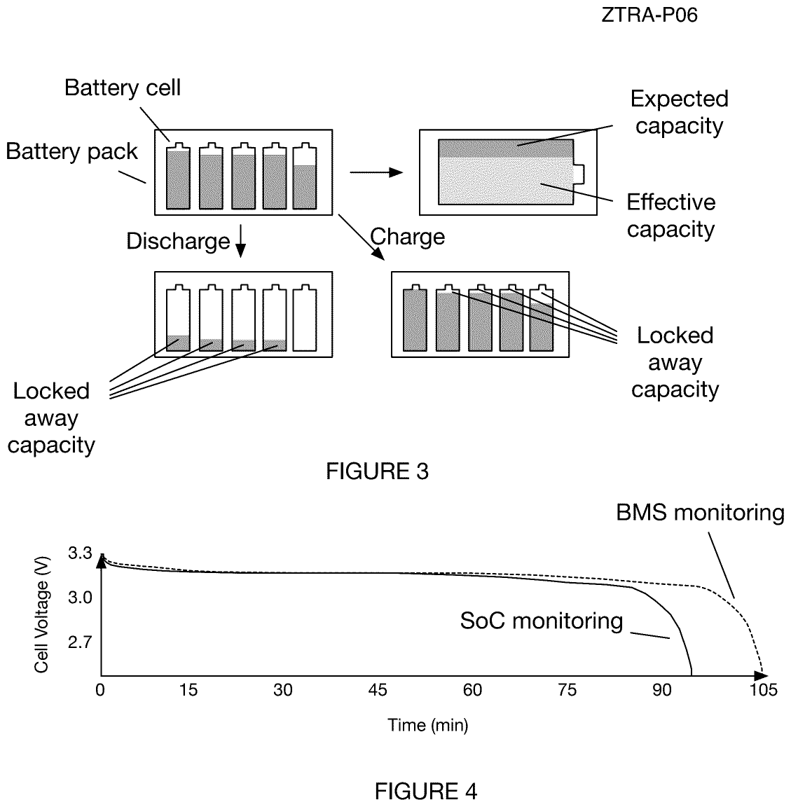

First, variants of the technology can improve a lifetime and/or usage of a battery pack (as shown for example in FIG. 3). For example, accurate rebalancing of battery cells can result in slower and/or more controlled degradation of a battery pack (as opposed to allowing the battery cells to become unbalanced, as compared to naïve rebalancing based on simplified models, etc.) thereby increasing lifetime (and relatedly improving performance such as total capacity) of the battery pack.

Second, the inventors have discovered that using traditional and/or simplified approaches (e.g., approaches that use a nominal voltage as a stand-in for state of charge) are not able to accurately rebalance cells (and/or may not detect an imbalance for a significant amount of time as shown for example in FIG. 4). For example, as shown for instance in FIG. 2, a battery cell (depending on the battery chemistry, in this specific example lithium iron phosphate cathode active material, but also true for other cathode and/or anode chemistries) can have a highly nonlinear relationship between an instantaneous open circuit voltage and a state of charge. For instance, a change of about 40 mV can be associated with a change of almost 60% SoC. Relatedly, the battery can undergo significant hysteresis (e.g., where the relationship between OCV and SoC depends on how the battery was recently operated) further hindering observability and predictability. As shown for example in FIG. 2, a lithium-ion battery (in this example a 280 Ah LFP battery, but similar results can be observed for other battery chemistries and/or capacity) can experience hysteresis between a maximum OCV and minimum OCV such as that the same OCV can correspond to SoCs that differ by more than 30%. To overcome these challenges, the inventors have discovered that modeling a state of charge for each battery cell (e.g., each battery cell in series), tracking changes in the SoC over time, and/or operating the battery cell in less common regions of the OCV-SoC curve (e.g., to improve observability) can result in improved cell rebalancing (e.g., because they are more accurate than using voltage monitoring alone, faster cell rebalancing such as by detecting an imbalance quicker than, and thereby beginning to rebalance quicker than, other approaches, etc.). In some variations, the inventors have found that a battery OCV can be ‘tapped’ (e.g., such as a repeated charging/discharging cycles at a given rate, for a given duration, for a given number of cycles, etc.) to settle and/or remove the effects of hysteresis (and thereby improve the determined battery state(s)). In some variations, a hysteresis model (e.g., a model that processes preceding states of the battery cell in addition to the current state and/or sensor measurements, a model that is modified to include hysteresis term(s), etc.) can be used to improve the prediction of the battery state (e.g., to account for hysteresis effects).

Third, variants of the technology enable cell rebalancing to be performed contemporaneously with battery pack operation. For example, rather than taking a battery pack and/or battery system offline to ensure proper battery cell rebalancing within the battery pack and/or battery system, variations of the technology can enable battery cells to rebalance while the battery pack and/or battery system is operated (e.g., active or passively managing the battery cells to more rapidly drain higher SoC cells, to more slowly drain lower SoC cells, to transfer charge from high SoC cells to lower SoC cells, etc.).

Fourth, variants of the technology can identify cells with a lowest nominal capacity within a battery pack. Based on the knowledge of the cell with the lowest nominal capacity, other battery cells within the battery pack can then be operated over a narrower range (ex: if cell A has 100% capacity SoH and Cell B has 75%, Cell A can operate in any 75% continuous window of its 100% range). In some examples, this information can be leveraged (e.g., based on application-level input from a host, based on battery degradation-optimization, etc.) to operate one or more of the other battery cells in the middle of their range (e.g., to minimize battery degradation), operate one or more of the other battery cells near the top of their capacity range (e.g., to maximize power/energy), operate one or more of the other battery cells near the bottom of their capacity range (e.g., to improve observability near low SoC), and/or can be operated in any suitable continuous range (e.g., a first subset of cells can be operated near the bottom of the range to observe those cells and a second subset of cells can be operated near the top of the range to maximize power and/or energy, where the cells in the first and second subset of cells may differ in different charging and discharging cycles).

Fifth, variants of the technology can enable a simpler (e.g., cost effective, weight efficient, fewer components, more space conserving, etc.) solution to battery balancing than retrofitting existing battery packs. Variations of the technology do not preclude retrofitting and/or upgrading battery pack (e.g., as the retrofit, upgrade, etc. can further improve, benefit, etc. the technology) with additional sensors to improve observability of and/or accuracy of battery cell state determination. For example, the technology can leverage validated models, battery pack specific models, models generated from (e.g., derived from) testing similar battery packs and/or other suitable models to accurately determine battery cell specific properties (also referred to as states) for each battery cell of a battery pack. Additionally or alternatively, variations of the technology can enable battery balancing with little or no downtime and/or without requiring operators to perform the battery balancing and/or without requiring specialty test equipment. Alternatively, even in situations where an operator is required to perform the balancing, the method can shorten the time by precomputing how to rebalance the cells without requiring further battery testing or monitoring.

Sixth, variants of the technology can modify (e.g., improve) battery safety and/or battery lifetime resulting from proper battery balancing. For instance, rather than charging when one or more battery cells within a battery pack (or module) are at full charge (i.e., SoC near 100%), variations of the technology can rebalance the cells at an SOC between 20-80% SoC (or at any suitable SoC) which can be safer and/or lead to longer battery lifetimes (as compared to holding one or more cells at or near 100% SoC). Relatedly, variants of the technology can enable a “home” (e.g., a default) SoC for where to balance the battery cells can be set to any value (e.g., is not limited to at or near 100%). For instance, a home SoC could be set to 50% (e.g., for energy storage systems, hybrid electric vehicles, etc.) and these variations could result in less frequent cycling to at or near 100% SoC for these batteries.

Seventh, variants of the technology can improve an observability into the state of the battery (e.g., SoH, SoC, SoP, SoE, etc.). For instance, a well-balanced battery pack can have better observability into the state of the battery pack as a whole and/or individual battery cells thereof as compared to an imbalanced battery pack. As another example, charge balancing chirps (e.g., voltage or current spikes) can be provided and/or leveraged to improve observability (e.g., into SoC, battery impedance, etc.).

Eighth, variants of the technology can enable continuous or near continuous charge balancing (e.g., also referred to as always on charge balancing) rather than being at top of charge or idle. For instance, using real-time or near-real time battery state estimation (e.g., for each battery cell within a battery module or battery pack) can enable those battery states to be leveraged in real or near-real time (e.g., contemporaneously with sensor data acquisition) to determine whether to balance the battery pack and/or module. Relatedly, variants of the technology can enable battery balancing without requiring or leveraging a rest. Additionally or alternatively, shorter rests can be and/or rest protocols can be included to achieve improved (e.g., faster, more precise, etc.) balancing.

However, further advantages can be provided by the system and method disclosed herein.

### 4. System

As shown for example in FIG. 6, the system 10 can include a computing system (e.g., processor) 200, which can include a state estimator (e.g., leveraging one or more models), a controller, and/or any suitable component(s). The system can optionally include a battery (e.g., battery pack 100, battery cell 105), one or more sensors 300, an input source (e.g., a user interface such as a touchscreen, stylus, buttons, haptics, auditory, user input, etc. at an operator device, the external system, a user device, etc.), one or more thermal elements (e.g., heat sources, heat sinks, HVAC system, vehicle temperature controller, etc.), and/or any suitable components. The system preferably functions to provide recommended operation parameters and/or control an external system to which the system is mounted, connected, coupled, in communication with, and/or otherwise interfaces with or is integrated into. The system can be coupled to one or more loads (e.g., each battery module or battery cell can be coupled to a separate load, the system can be coupled to a plurality of loads where each battery module or battery cell can be configured to switch between which load the battery module or cell is connected to, where each load can be distinct such as different impedance, capacitance, resistance, reactance, inductance, admittance, susceptance, conductance, transconductance, etc.). However, the system can additionally or alternatively function in any manner.

The battery(s) function to provide power to the computing system, the external system (e.g., a load), and/or a component thereof (e.g., a motor, a camera, a load, etc.), and/or can otherwise provide power to any suitable components or systems. The battery(s) are preferably secondary cells (e.g., rechargeable battery), but can be primary cells (e.g., not rechargeable battery), and/or any suitable battery, capacitor, and/or supercapacitor. The battery is preferably mounted to (e.g., integrated in) the external system, but can be remote from the external system (e.g., provide energy to the external system wirelessly), and/or can otherwise be arranged.

Each battery can include one or more: battery cells (e.g., a container to store chemical energy such as a prismatic battery cell, pouch battery cell, cylindrical battery cell, etc.; including an anode, cathode, separator, electrolyte, current collector, etc.), battery modules (e.g., groups or clusters of battery cells), battery packs (e.g., an enclosure that includes one or more battery cells or battery modules, processors configured to run software, heating and/or cooling systems, etc. that delivers power to the components of the external system or loads such as inverters, boost converters, transformer, rectifier, rectiformer, adapter, etc.), and/or any suitable components.

Each battery can be described by a set of battery properties. The battery properties can be cell-specific properties, module-specific properties, pack-specific properties, generic properties, and/or any suitable properties. The properties can be static (e.g., fixed such as determined at the time of installation or manufacture) and/or variable (e.g., change during operation of the battery, change over time as the battery ages, change depending on the number of battery operation cycles, etc.). Battery properties can be: directly measured; calculated, derived, inferred, or estimated (e.g., from directly measured battery properties, from simulations, from charging or discharging the battery, etc. often in such cases referred to as battery state(s)); received (e.g., from a manufacturer, from an operator, from a data sheet, etc.), and/or otherwise be accessed. Battery properties can include internal battery properties and/or external battery properties (e.g., properties associated with an environment that the battery is in).

Exemplary battery properties include: voltage (e.g., open circuit voltage, instantaneous voltage, nominal voltage, voltage limits, maximum voltage, minimum voltage, etc.), current (e.g., short circuit current, instantaneous current, end-of-life current limits, beginning-of-life current limits, end-of-life current capabilities, beginning-of-life current capabilities, taper currents, etc.), temperature (e.g., internal temperature; surface temperature; environment temperature; set temperature; local temperature such as an average temperature of a battery cell, temperature within a predetermined area or volume of the battery, etc.; average temperature, etc.), temperature gradient (e.g., within an external system, across a battery cell, across a battery module, across a battery pack, etc.), humidity, pressure (e.g., environmental pressure, mechanical pressure, air pressure, etc.), resistance (e.g., internal resistance, ohmic resistance, capacitive resistance, inductive resistance, instantaneous resistance, etc.), impedance, capacity (e.g., specific capacity), capacitance (e.g., effective capacitance), inductance, component thickness (e.g., anode thickness, cathode thickness, separator thickness, solid-electrolyte interface layer thickness, etc.), cell swelling (e.g., a change in cell thickness or other dimension such as due to gas formation), particle radius (e.g., anode particle radius, cathode particle radius, etc.), transference number, Brugman number (e.g., a representation of electrode particle tortuosity), solution diffusivity, solution volume fraction (e.g., anode, cathode, separator, etc. solution volume fraction), diffusivity (e.g., anode solid diffusivity, cathode solid diffusivity, etc.), reaction rate (e.g., anode reaction rate, cathode reaction rate, etc.), materials (e.g., cathode material, anode material, electrolyte material, separator, etc.), geometry, size, solution conductivity, entropic heating coefficient, thermal conductivity, electrical conductivity, thermal mass, C-rate (e.g., nominal C-rate, maximum C-rate, etc.), charge (e.g., maximum charge, charge current limit, discharge current limit, delivered charge, stored charge, etc.), state (SoX) of the battery (e.g., state of charge (SoC), state of health (SoH), state of power (SoP), state of energy (SoE), state of safety (SoS), etc.), energy (e.g., energy delivered since last charge or discharge, total energy delivered for a given period of time, etc.), power, time (e.g., time since last charge or discharge, age, remaining lifetime, etc.), battery age (e.g., time since battery manufacture, total number of charging and/or discharging cycles, amount of time the battery has been at a target or threshold charge, etc.), ion concentration (e.g., lithium ion concentration), and/or any suitable properties.

The optional sensor(s) 300 function to measure sensor data that can include one or more battery properties (e.g., directly measurable battery properties), external system properties, environmental conditions (e.g., of an environment proximal to, surrounding, adjacent to, near, etc.) of the battery or external system, and/or any suitable properties. The sensors can be connected to (e.g., in contact with) the battery(s), collocated with (e.g., mounted to) the external system, remote from the external system (e.g., a wireless sensor), within a threshold distance of the battery and/or components thereof, and/or otherwise be configured. In variants, each cell of a battery can include a sensor, each module of a battery can include a sensor, each battery pack can include a sensor, a subset of cells can include a sensor, a subset of modules can include a sensor, a subset of packs can include a sensor, and/or the sensor can otherwise be associated with any suitable battery(s) and/or load (e.g., a motor, radio, camera, light, resistor, capacitor, etc. such as of an external device).

Exemplary sensors include: battery management systems (BMS) monitors, thermometers, pressure gauges, external system sensors (e.g., odometers, altimeters, power sensors, inertial measurement unit sensors, accelerometers, gyroscopes, etc.), anemometer, weather sensors (e.g., illumination sensors, humidity sensors, road condition sensors, etc.), clocks, electrochemical impedance spectroscopy (EIS) sensors, voltmeters, ammeters, ohmmeters, multimeters, and/or any suitable sensors (e.g., any sensor whose reading is directly or indirectly affected by or correlated with the battery state, any sensor whose outputs are directly or indirectly correlated with a battery property, etc.).

The computing system 200 preferably functions to determine a state (e.g., state of charge, state of health, state of power, state of energy, state of safety, etc.) of each cell of a battery pack and/or module and to provide instructions that can be used to rebalance the cells of the battery pack. However, the computing system can otherwise function. The computing system can be local (e.g., to the system, to the external system, etc.), remote (e.g., server, cloud computing system, etc.), and/or distributed (e.g., between an edge or local computing system and a remote computing system, between two or more local computing systems, between remote computing systems, etc.). The computing system can include any suitable processors (e.g., CPU, GPU, TPU, etc.), microprocessors, application-specific integrated circuit (ASIC), field-programmable gate array (FPGA), memory, controllers (e.g., a controller as described in U.S. patent application Ser. No. 18/913,656 titled ‘SYSTEM AND METHOD FOR DEGRADATION BASED BATTERY CONTROL’ filed 11 Oct. 2024 which is incorporated in its entirety by this reference), and/or other components.

The state estimator preferably functions to estimate a state (e.g., a current state, a future state, etc.) of the battery and/or external system. The state estimator can be on a local computing system, can be on a remote computing system (e.g., run on a cloud server), can be distributed (e.g., run on a local and remote computing system, include a first local state estimator and a second remote state estimator, etc.), and/or can otherwise be implemented.

Inputs to the state estimator can include: sensor data, filtered data, schedule(s) (e.g., selected mode(s) such as model(s), model noise covariance, hyperparameters, sensor noise covariance, active parameters, inactive parameters, active parameter covariances, etc.; schedules as disclosed in U.S. patent application Ser. No. 17/959,998 titled ‘SYSTEM AND METHOD FOR BATTERY MANAGEMENT’ filed 4 Oct. 2022, which is incorporated in its entirety by this reference; etc.), battery properties, battery states (e.g., historic battery states, as shown for example in FIG. 4, etc.), external system properties, controlled inputs (e.g., a load profile), uncontrolled inputs (e.g., environmental temperature, impact magnitude, impact frequency, etc.), and/or any suitable inputs.

Outputs (e.g., states) from the state estimator can include: states of the battery (e.g., predicted state of the battery during or after operating the battery), battery properties (e.g., true battery properties, denoised battery properties, etc.), states of the external system, parameters of the model (e.g., active parameters of the model), model error (e.g., estimates of an error in the model parameters), time (e.g., lifetime of the battery), and/or any suitable states. For example, outputs (e.g., states determined by) of the state estimator can include a state of charge, state of health (e.g., capacitance state of health), temperature, electrochemical state (e.g., cathode ion distribution), model parameters (such as charge capacity and/or other parameters that determine the battery's general performance capability), and/or any suitable outputs.

The state estimator can include: a Kalman filter, an extended Kalman filter, a dual extended Kalman filter, an unscented Kalman filter, a Schmidt-Kalman filter, an ensemble Kalman filter, a Gaussian process, a look-up table, a Markov Chain Monte Carlo technique, linearization techniques, machine learning techniques (e.g., a neural network), and/or any suitable particle filter, sequential Monte Carlo technique, or other state estimator. The state estimator (e.g., type, where the state estimator runs, etc.) can depend on an accuracy of the estimated state (e.g., a target accuracy, based on the application, etc.), an amount of processing power available, and/or otherwise depend on any suitable properties.

In some examples, the state estimator can be a state estimator as disclosed in U.S. patent application Ser. No. 17/314,867, titled ‘BATTERY ANALYSIS SYSTEM AND METHOD’ filed 7 May 2021 which is incorporated in its entirety by this reference. However, any suitable state estimator can be used.

The model preferably functions to determine one or more battery property (e.g., derived battery property) based on the sensor data. The model is preferably implemented as part of a local computing system (e.g., edge computing). However, additionally or alternatively the model can be implemented as part of a remote computing system (e.g., run on a cloud server), can be distributed (e.g., run on a local and remote computing system, include a first local model and a second remote model, etc.), and/or can otherwise be implemented.

Inputs to the model can include a battery state (e.g., estimated by the state estimator), sensor data (e.g., sensor readings), schedules (e.g., selected models, model noise, etc. such as schedules as disclosed in U.S. patent application Ser. No. 18/235,691 titled ‘SYSTEM AND METHOD FOR BATTERY MANAGEMENT’ filed 18 Aug. 2023 which is incorporated in its entirety by this reference), external system properties, controlled inputs (e.g., battery operation profile such as anticipated load profile, historic load profile, etc.), uncontrolled inputs (e.g., potential battery operation conditions that are not fully controlled by a battery operator), battery degradation (e.g., predicted, target, desired, etc. relationship between one or more battery property(s) as a function of time), and/or any suitable inputs can be generated. The battery degradation can be a manufacturer specified degradation, a user specified degradation (e.g., a maximum acceptable degradation, a minimum reasonable degradation, a target degradation, etc.), an optimized degradation (e.g., a degradation curve optimized to ensure battery failure occurs during or outside a warranty period, a degradation curve that minimizes degradation of a battery property potentially at the expense of another battery property over time, etc.), and/or any suitable degradation can be used. The degradation can be linear, polynomial, exponential, logarithmic, logistic, and/or have any suitable functional form. As a specific example, a battery degradation model can provide a relationship of a battery cell state of health as a function of inputs across time.

Outputs from the model can include one or more battery properties, errors in the battery properties, time(s) (e.g., time stamps) associated with the battery properties, predicted battery properties at a predetermined time (e.g., time relative to the aging of the battery), predicted battery aging, and/or any suitable outputs. The outputs are preferably generated by processing the inputs according to one or more model.

The models can include battery models, sensor models, system models, plant (e.g., energy storage plant) model, a load model and/or any suitable models. The sensor model(s) can function to model how sensor data is acquired, an error associated with sensor measurements, sensor biases, and/or otherwise model the sensor behavior. The battery models are preferably physical models (e.g., model a physical aspect of the battery; model battery physics; etc.), but can alternatively be conceptual models, empirical models, heuristic models, hybrid models, interpretable models, and/or other models. The battery models can function to model (e.g., form a representation of) how the battery operates and/or responds to charging or discharging. For example, battery models can simulate electrical effects, thermal effects, diffusion effects, ion effects, electrochemical effects, aging effects (e.g., predict a future battery property based on current and historic battery properties, predict battery properties at a given time or age for given controlled and/or uncontrolled inputs, etc.), quantum effects, and/or any suitable effects.

The models are preferably parameterized models. However, the models can additionally or alternatively include nonparameterized models, machine learning models (e.g., neural networks), and/or any suitable model types. Parameterization generally refers to what independent variables are associated with a dependent variable and a functional form for how the dependent variable changes with the independent variable. Parameterization can additionally or alternatively include: what elements are lumped together (e.g., how many individual units are described by a given term), and/or otherwise be defined. In an illustrative example, open-circuit voltage (U) can be parameterized as a function of state of charge (SoC), temperature (T, e.g., internal temperature of the battery, environmental temperature, etc.), and/or age of the battery such as: U(SoC,T, age), U(SoC, age), U(T, age), U(SoC,T), U(SoC), U(T), U(age), or U; where f(x) means function f of independent variables x.

Exemplary functional relationships include: polynomials (e.g., constant, linear, quadratic, cubic, quartic, quintic, etc.), exponentials, logarithms, trigonometric functions, logistic functions, hyperbolic functions, sigmoidal functions, radical functions (e.g., square roots, cube roots, etc.), rational functions, transcendental functions, power functions, special functions (e.g., Bessel functions, hypergeometric functions, error functions, delta functions, sine functions, etc.), differentials (e.g., differentials with respect to time, space, battery properties, etc.), integrals (e.g., with respect to time, space, battery properties, etc.), and/or any suitable functions.

Each parameterization is preferably associated with a set of parameters, where the set of parameters scale or otherwise relate the independent variable to a dependent variable. For instance, in the parameterization of U(SoC, T)=A*SoC+B*T+C; A, B, and C are the set of parameters. The independent variables can be associated with (e.g., be, be derived from, be associated with, etc.) one or more sensor measurements, states (e.g., estimated by a state estimator), simulated system properties, and/or any suitable variables. When a variable is not directly measured (e.g., is determined by combining one or more other measured quantities), the variable can be referred to as a ‘hidden variable.’ However, a hidden variable can otherwise be defined.

The parameters can be active or inactive. Active parameters are preferably parameters that are updated during the use of (e.g., evaluation of, training, determination of, etc.) the model (e.g., are updated, output, etc. by the state estimator). Inactive parameters are preferably parameters that do not change while using the model. The identification of a parameter as an active or inactive parameter can be depend on: a relationship between the parameter and a physical model (e.g., a physical constant can be an inactive parameter), an impact of changes in the parameter to a quality (e.g., accuracy, precision, compute required, processing speed, etc.) of the model (e.g., parameters with a smaller impact can be inactive parameters, parameters with a larger impact can be active parameters, etc.), a covariance between variables or parameters (e.g., when two parameters have a correlation coefficient greater than about 0.5, 0.6, 0.7, 0.8, 0.9, 0.95, 0.99, values therebetween, etc. at least one of the parameters can be inactive), an error in a variable associated with the parameter, an error or uncertainty in determining the parameter value, and/or can otherwise be identified or selected. Inactive parameters can become active parameters and active parameters can become inactive parameters (e.g., as more data is received; as one or more battery properties change; depending on the current use or application of the model such as for state estimation, for prediction, for safety determination, for anomaly prediction, etc.; depending on the current use of the battery such as charging, discharging, storing, active use, etc.; etc.).

The model(s) can include, for example, a thermal model (e.g., a model for determining the thermal distribution, local temperature, thermal diffusion within a battery, battery pack, battery cell, external system, etc.), a heat generation model (e.g., a model for how much heat is generated during operation of the battery such as from electrical charging and/or discharging of the battery, from other heat generating components, etc.), an electrical model (e.g., modeling a battery, battery cell, etc. as a voltage source, resistor, capacitor, inductor, diode, or other electrical component), an electrochemical model, a heat transport model (e.g., a model for how heat is transported within and/or between components), a degradation model, an ion transport model (e.g., Li⁺ transport model), a quantum mechanical model, and/or any suitable models.

In a first illustrative example, a thermal model (e.g., for a temperature distribution, thermal diffusion, local temperatures, etc. within a battery pack or external system) can be represented as: \dot{T}ᵢ=Σⱼ M_{i,j}Tⱼ+bᵢ, where \dot{T}ᵢ is the change in temperature with respect to time of element i (e.g., where an element can refer to a cell, a group of cells, a cell and nearby thermal mass, a component of a cell, etc.), M_{i,j} is a matrix of interdependencies relating the current temperature distribution to the rate of change of the temperature distribution at each element, Tⱼ is the temperature of element j, and bᵢ is a source term (e.g., boundary conditions, electrochemical heat generation, external sources, etc.). In a second illustrative example, an electrothermodynamic heat generation model can be represented as:

$$\dot{Q} = {\dot{Q}}_{irrev} + {\dot{Q}}_{rev} = I ( U - V ) - IT \frac{\partial U}{\partial T} {\vert}_{q} ,$$

where \dot{Q} is the change in heat of an element, \dot{Q}ᵢᵣᵣₑᵥ can be attributed to a change in heat due to an internal resistor, \dot{Q}ᵣₑᵥ can be attributed to changes in heat due to reversible processes, I is the element current, U is the element open circuit voltage, V is the potential drop of the element, T is the temperature, and q is the charge. In a third specific example, a battery cell can be modeled as a voltage source (e.g., a voltage source with a voltage approximately equal to the open circuit voltage) and a resistor (e.g., with an internal resistance). In a variation of the third specific example, the internal resistance can be modelled according to R=V/I (where R can be the internal resistance of the cell or supercell, V can be approximately an open circuit voltage of the cell, and I can be the current). In a second variation, the internal resistance can be modelled as a function of battery state of charge, internal temperature (e.g., which can be a modelled value or a measured value), current, voltage (e.g., open circuit voltage), ion distribution within the battery, ion diffusion within the battery, and/or any suitable term(s) or combinations. In a fourth specific example, a battery pack can be modelled as a plurality of battery cells, with n cells in series and N cells in parallel. In a fifth illustrative example, a battery pack can be modeled as N cells in parallel (e.g., where cells in series can be modeled as a single effective cell). In a sixth illustrative example, an equivalent circuit model can be parameterized by a relationship among information (e.g., temperature, state of charge, age, battery properties, battery states, etc.) pertaining to, associated with, and/or describing a battery. In a seventh illustrative example, an electrochemical model can include and/or be represented by one or more: equivalent circuit models, combinations of equivalent circuit models with electrical components, fully electrochemical models (e.g., single particle models, single particle models with electrolyte, first principles electrochemical models, etc.), integrated electrochemical and thermal models (e.g., tracking temperature and lithium concentration such as in another electrochemical model), and/or any suitable electrochemical models. However, any suitable models can be used.

The computing systems preferably tracks changes in the battery state of each battery cell over time. These changes in battery state overtime can be used to determine how to rebalance the cells within a pack. However, the state estimator and/or modeler can track and/or not track any suitable information.

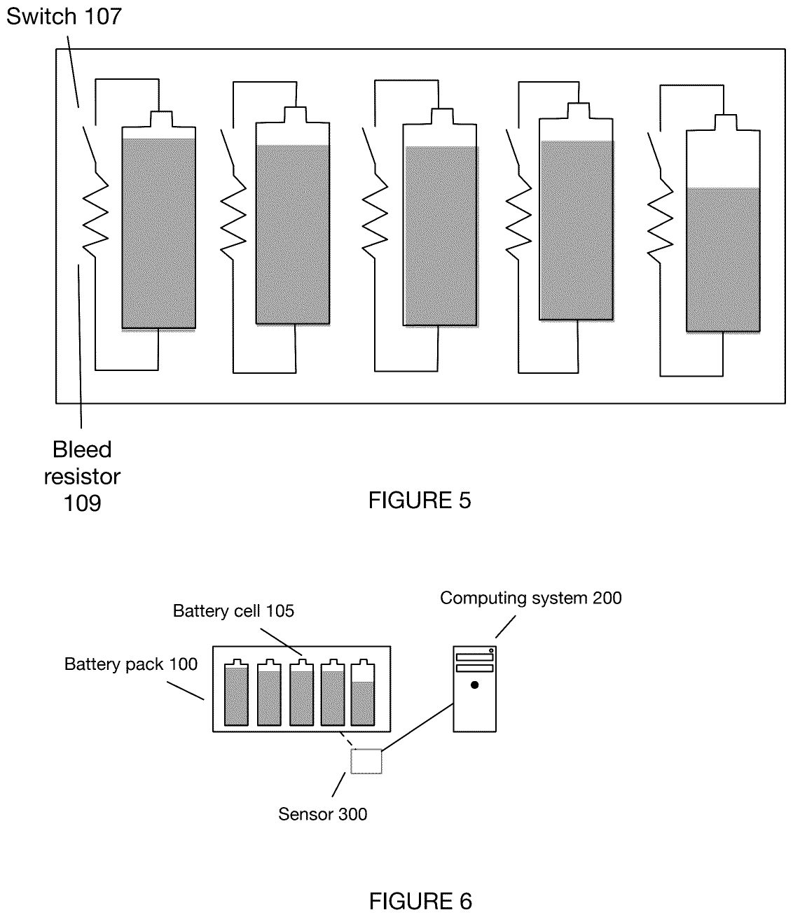

The system can include a battery balancer. The battery balancer can include passive battery balancer(s) (e.g., battery regulator, balance resistor, bleed resistor 109, bypass resistor, discharge resistor, as shown for example in FIG. 5, etc.) and/or active battery balancers 107 (e.g., capacitor, inductor, DC-DC converters, multi pin connector that applies a charge or discharge current, etc.). In some variants, the battery balancer can provide a technical advantage of improving an observability of a battery state (for instance, the battery balancer can apply a discharge pulse, connection to the battery balancer can result in a jump change in current, etc. where the discharge event and/or discharging can be used to improve estimation of the battery state such as because it has a predictable value, source, timing, etc.).

In some variants, the battery balancer can be controlled in more than one way (e.g., in more than one mode of operation). For example, the battery balancer can include more than one sub-component, where each sub-component can be controlled independently. As another example, one battery module can have balancing enabled while another battery module does not have balancing enabled.

### 5. Method

As shown in FIG. 1, the method can include receiving sensor measurement(s) S100, estimating battery property(s) S200, balancing battery cells S300, operating the battery pack S400, and/or any suitable steps. The method is preferably performed on a system that includes a battery pack (e.g., including two or more battery cells in series), one or more sensors, one or more computing systems, and/or any suitable system.

The method is preferably performed in real or near-real time (e.g., relative to a sensor latency, to a battery-operated system operation time, etc.), but can be performed delayed and/or with any suitable timing. The method (or steps thereof) are preferably performed automatically (e.g., continuously), but can be performed responsive to a trigger, a request or call for method operation, manually (e.g., responsive to a request from an operator or user), and/or with any suitable timing. The method is preferably performed by a system as described above, but can be performed by any suitable system.

Receiving sensor measurements S100 functions to receive sensor measurements associated with a battery of the battery-operated system. The sensor measurements are preferably made by a sensor, but can be made by any suitable component. The sensor measurements can be received from the sensor, received from a computing system (e.g., memory, storage, database, etc.), and/or from any suitable component. The sensor measurements can include non-local measurements (e.g., measurements not tied to a specific battery cell) and/or local measurements (e.g., one or more sensor measurements for each battery cell). In variants, each cell of a battery can include a sensor, each module of a battery can include a sensor, each battery pack can include a sensor, a subset of cells can include a sensor, a subset of modules can include a sensor, a subset of packs can include a sensor, and/or the sensor can otherwise be associated with any suitable battery(s).

Examples of sensor measurements include: temperature (e.g., average temperature, instantaneous temperature, surface temperature, internal temperature, etc. such as at a heat sink coupled to a plurality of battery cells), pressure (e.g., cell swelling against a physical constraint), force (e.g., impact), voltage (e.g., instantaneous voltage, open circuit voltage, etc.), current (e.g., instantaneous current, short circuit current, etc.), and/or any suitable sensor data.

Determining a battery state S200 functions to determine one or more battery property. S200 is preferably performed using a state estimator (e.g., as described above), but can be performed using a model (e.g., a model defining a relationship between a battery state and one or more sensor measurements) and/or in any suitable manner. The battery properties can be determined from individual sensor measurements, individual sensor measurement time points, a plurality of sensor measurements, historical sensor measurements, and/or any suitable sensor measurements. The battery state is preferably retained (e.g., stored) to facilitate tracking of changes in the battery state over time. S200 can determine a battery state for each battery cell of the battery pack, each battery module of the battery pack, a subset of battery cells of the battery pack (e.g., identified as more likely to need balancing, identified as energy limiting, based on a load or loads connected or connectable to the battery cells, based on an operator input, or otherwise identified as needing to be predicted as opposed to other cells that need not have their battery state predicted), a subset of battery modules of the battery pack (e.g., identified as more likely to need balancing, identified as energy limiting, based on a load or loads connected or connectable to the battery modules, based on an operator input, or otherwise identified as needing to be predicted as opposed to other modules that need not have their battery state predicted), and/or can estimate a battery state for any suitable battery.

Typically, all battery cells (or battery modules) are estimated in the same manner. However, in some variants, using different battery estimation methods for different battery cells or battery modules can be desirable (e.g., for improved accuracy, improved observability, reduced computation time, for a battery state observation frequency, etc.). For instance, a higher accuracy battery state can be estimated for a first set of batteries and a lower accuracy battery state (e.g., using a less accurate state estimator, less accurate model, etc.) can be estimated for a second set of batteries (e.g., e.g., at an equal or greater frequency as the battery state for the first set of batteries). The sets of batteries can be predetermined, determined during the performance of the method (e.g., based on how frequently a battery is rebalanced, based on changes in the battery state, etc.), be determined by an operator, and/or can otherwise be determined.

For instance, S200 can determine (e.g., calculate, estimate, etc.) a battery state of charge, state of health, local battery cell temperature, battery impedance, internal temperature, ohmic resistance, ion distribution, and/or other suitable battery properties or states can be determined.

In some variants, S200 can include tracking (e.g., storing, monitoring, etc.) the battery state (e.g., the state of charge) for each battery cell in a battery pack (e.g., for a threshold time duration, for a threshold number of charge and discharge cycles, during an instantaneous use of the battery pack, etc.).

In some variants, system components can be modulated to improve sensor measurements and/or battery properties derived therefrom. For instance, a resistance (e.g., of a bleed resistor, of a sensor resistor, etc.) can be modulated to improve observability of battery states.

Balancing the battery cells S300 preferably functions to move charge (e.g., between cells, remove relative excess charge from cells to enable the remaining cells to receive further charge, etc.) within a battery pack. S300 is preferably performed “online” (e.g., while the battery pack is being used to provide energy to a load, contemporaneously with S400, etc.). However, S300 can be performed “offline” (e.g., when the battery pack is not used to provide energy to a load).

The battery pack is preferably rebalanced to an optimal balance point. The optimal balance point can be provided, for instance, as a scalar utility value (e.g., included in an optimization function). The optimal balance point can refer to a balance point for the battery pack (e.g., collection of battery cells as a whole), a balance point for each battery cell separately, a balance point for each subset of cells (e.g., subset of cells in parallel, subset of cells in series, etc.), and/or can be a balance point for any suitable battery cell(s) and/or pack(s). The optimal balance point can be a “balance at the top” (e.g., balance the battery cells to maximize the total capacity within the battery pack), “balance at the bottom” (e.g., balance the battery cells to minimize the amount of residual capacity when a battery cell within the pack has an SoC of approximately 0%), a balance set point or balance window (e.g., selected based on an impedance growth model, observed state, etc.) that avoids high and/or low SoC regimes (e.g., avoids SoC values when the internal resistance values for one or more battery cells get steeper than a threshold value; for example SoC between about 20-60%, 70-90%, 60-90%, 20-90%, 40-90%, 10-60%, 10-90%, 5-95%, etc.), a balance point or window that optimizes for battery pack lifetime (e.g., when there is no single balance for every cell or cell group that maximizes capacity), a balance point or window that optimizes for available battery pack power, a balance point or window that optimizes for available energy over a given time range, and/or can include any suitable balance point and/or balance window.

The battery cells are preferably balanced based on the state of charge (and the state of health) of the battery cells. The battery cells can be balanced over an entire battery state curve (e.g., at all or most state of charge values of the battery cells), only at a subset of battery states (e.g., when the state of charge is within a narrower balancing window such as 70-80%), and/or at any suitable time. However, the battery cells can additionally or alternatively be balanced based on a voltage of each battery cell and/or based on any suitable battery state(s) and/or property(s).

In variants that only balance based on the state of charge can result in an imbalance in the battery cells (e.g., when there is a variation in a capacity of the battery cells). In these variants, the imbalance can be mitigated (e.g., prevented, avoided, minimized, etc.) by balancing based on a combination of state of charge and state of health (e.g., capacity state of health).

Balancing the battery cells can include discharging (e.g., to a balancing resistor, converting the electrochemical energy to heat, etc.) one or more battery cell (e.g., battery cells with higher SoC compared to other cells within the battery pack), moving electrochemical energy between battery cells (e.g., by using one or more battery cells to charge a capacitor and subsequently using the charged capacitor to provide additional charge to one or more other battery cells), tailoring the amount of charge flowing into or out of each cell within a battery pack, and/or can include any suitable steps.

Balancing the battery cells can include separating the battery cells into a first set of battery cells and a second set of battery cells. Without being limited to this terminology, the first set of battery cells can be battery cells that have a higher state of charge (e.g., relative SoC accounting for SoH) while the second set of battery cells can be battery cells that have a lower state of charge (e.g., relative SoC accounting for SoH). The battery cells can be assigned to the first or second set of battery cells based on a battery state metric (e.g., when a battery state metric is met). The battery state metric can be an individual metric for a battery cell (e.g., a metric for each battery cell of a battery pack or module), an aggregate metric (e.g., for all battery cells of a battery pack or module), and/or can be another suitable metric. An exemplary aggregate battery state metrics can include battery state variability (e.g., a threshold raw, standardized, L-, or central moment with order greater than or equal to 2 of the battery states such as variance, semivariance, standard deviation, skew, kurtosis, etc.). An exemplary individual battery state metric can include a relative value between the battery state for an individual battery cell (e.g., compared to the lowest or highest battery state for a battery cell of the battery pack). However, other suitable battery state metrics can be used. As an illustrative example, any battery cell with a difference in state of charge (or relative state of charge corrected based on the state of health) greater than a threshold value (e.g., 1%, 3%, 5%, 10%, 15%, etc.; set or determined based on an application; set or determined based on an accuracy or validity of the state estimates; etc.) less than the state of charge for the battery cell with the maximum battery state of charge can be included in the second set of battery cells. As a second example, when an aggregate battery state metric exceeds a threshold (e.g., standard deviation of SoC greater than 1%, 3%, 5%, 10%, 15%, 20%, etc.), a threshold number of battery cells (e.g., starting from the lowest state of charge battery cell and working up to successively higher SoC until the threshold number is achieved; optionally excluding battery cells to be excluded as identified for potential anomalies or failures) of the battery pack can be in the second set of battery cells.

Typically, the first set of battery cells are operated in a manner that brings the second set of battery cells into balance with the first set of battery cells. For instance, the first set of battery cells can be used to charge the second set of battery cells. As another example, the first and second sets of battery cells can be differentially operated (e.g., both sets can power the same load with battery cells of the first set further being discharged over a bleed resistor or other charge balancer until the battery cells would no longer be separated into a first and second set, until the second set has no battery cells, etc.). As a third example, in variants that include a plurality of loads and/or balancing systems, the loads can be differentially controlled to bring the batteries into balance. As a first variation of the third example, two battery modules of a grid storage system can each be coupled to a distinct (separately controllable) inverter (e.g., battery module A can be coupled to inverter A while battery module B can be coupled to inverter B). In this first variation, when one of the battery modules is more imbalanced (e.g., battery module B is further from balance than battery module A), the load can be shifted to battery module A (e.g., by controlling inverter A to provide more power as in this specific variation battery module A cells are more highly charged). Shifting this load can provide a technical advantage of resulting in more efficient battery balancing in battery module B. This first variation could also overcome limitations for combined inverter control and balancing control in a system (for instance, if modules cannot operate balancing while discharging at high rate, alternating a higher rate in one battery module and inverter and a lower rate in the other battery module can enable each battery module to rebalance themselves during the low rate period). As a second variation, the battery cell or modules can be connected to different battery balancers or loads (e.g., based on different discharging rates or properties to achieve balancing between the battery cells or modules). However, the battery cells can otherwise be balanced. In some variants, greater numbers of sets of battery cells can be used (e.g., a third set where the third set is discharged to a load along with the first set and the second set is charged by the first set). In another variant (that can be combined with the preceding variant), different sets of batteries can be coupled to different loads. For instance, batteries in a set with a higher state of charge can be coupled to larger loads while batteries in a set with a lower state of charge can be coupled to small loads.

The sets of battery cells are preferably continually updated (e.g., in real time, as new sensor measurements come in, during operation of the battery pack, etc.). When the batteries are balanced (e.g., the second set of battery cells includes no cells), S300 can be terminated (e.g., all of the battery cells can be discharged to the load normally, until a new battery cell is identified to be in the second set of battery cells).

Operating the battery S400 functions to charge and/or discharge the battery (e.g., to provide power, charge, electricity, etc. to a load). S400 is preferably performed contemporaneously with (e.g., simultaneously, concurrently, etc.) with S300. However, S400 can be performed before and/or after S300. In some variants, the battery operation can be modified to accommodate simultaneous balancing and battery operation (e.g., redistributing battery cell operation to simultaneously operate the load and balance the cells).

S400 can include generating battery operating instructions (e.g., instructions for how fast to charge or discharge the battery, instructions for how fast to charge or discharge individual cells within a battery pack, operating temperature for the battery, when or how long to provide downtime for cell balancing, etc.), where S400 can include performing the battery operating instructions (or providing the recommend operations to an operator). In a preferred example, S400 can exclude resting instructions during the battery operation (e.g., during balancing).

### Illustrative Examples

A numbered list of specific examples of the technology described herein are provided below. A person of skill in the art will recognize that the scope of the technology is not limited to and/or by these specific examples.
1. A method for balancing a battery pack comprising: measuring sensor data associated with the battery pack; estimating a state of charge for a plurality of battery cells (e.g., each battery cell, a majority of battery cells, a subset of battery cells, etc.) of the battery pack using the sensor data; when a state of charge threshold is met, determining a first set of battery cells in the battery pack and a second set of battery cells in the battery pack, wherein each battery cell of the battery pack is in at most (e.g., only) one of the first set or the second set; and balancing the second set of battery cells in the battery pack relative to the first set of battery cells in the battery pack.
2. The method of illustrative example 1, wherein each battery cell is assigned to the first set of battery cells or the second set of battery cells based on the state of charge for the respective battery cell.
3. The method of illustrative example 1 or 2, wherein the state of charge threshold is a threshold variation across the state of charges for each battery cell of the plurality of battery cells.
4. The method of any of illustrative examples 1-3, wherein the state of charge threshold is a threshold difference between a highest state of charge and a lowest state of charge among each battery cell of the plurality of battery cells.
5. The method of illustrative example 4, wherein the battery pack is balanced at a state of charge between 20-80%.
6. The method of any of illustrative examples 1-5, wherein balancing the second set of battery cells in the battery pack relative to the first set of battery cells in the battery pack comprises: discharging the first set of battery cells to a load; and contemporaneously with discharging the first set of battery cells to the load, charging the second set of battery cells using the first set of battery cells.
7. The method of any of illustrative examples 1-5, wherein balancing the second set of battery cells in the battery pack relative to the first set of battery cells in the battery pack comprises: discharging the first set of battery cells and the second set of battery cells to a load; and contemporaneously with discharging the first set of battery cells and the second set of battery cells to the load, discharging each battery cell of the first set of battery cells using a separate bleed resistor.
8. The method of any of illustrative examples 1-7, further comprising contemporaneously with balancing the second set of battery cells in the battery pack relative to the first set of battery cells in the battery pack: measuring a second set of sensor data; estimating a second state of charge for each battery cell of the battery pack using the sensor data; and when the state of charge threshold is no longer met, halting balancing the second set of battery cells.
9. The method of any of illustrative examples 1-8, wherein balancing the second set of battery cells does not comprise resting the first and second sets of battery cells.
10. The method of any of illustrative examples 1-9, wherein determining the state of charge comprises: processing the sensor measurements using a state estimator comprising on of: a Kalman filter, an unscented Kalman filter, an extended Kalman filter, a dual extended Kalman filter, a Schmidt-Kalman filter, a Gaussian process, or a particle filter; wherein the state estimator uses one or more model selected from: battery pack geometry model, sensor model, electrical components model, thermal transport model, battery cell heat generation model, battery cell heat transport model, equivalent circuit model, or a battery cell electrochemical model; wherein the model a parameterized model, wherein the parameterized model is parameterized as a function of one or more of: temperature, current, voltage, resistance, state of charge, battery age, time, or combinations thereof.
11. A system comprising: a battery pack comprising a plurality of battery cells; a sensor connected to the battery pack and configured to measure sensor data associated with the battery pack; and a processor in communication with the sensor wherein the processor is configured to: receive the sensor data associated with the battery pack; estimate a state of charge for each battery cell of the battery pack using the sensor data; for each battery cell of the battery pack: determine whether the respective battery cell is a member of a first set of battery cells in the battery pack or a second set of battery cells in the battery pack based on the state of charge (and/or state of health or other state of) of the respective battery cell, wherein each battery cell of the battery pack is in at most (e.g., only) one of the first set of battery cells or the second set of battery cells; and provide instructions for balancing the second set of battery cells in the battery pack relative to the first set of battery cells in the battery pack.
12. The system of illustrative example 11, wherein the processor is configured to determine whether to determine whether a respective battery cell is a member of the first set of battery cells in the battery pack or the second set of battery cells in the battery pack when a variation across all of the state of charges for each battery cell exceeds a threshold variation.
13. The system of any of illustrative example 11-12, wherein the second set of battery cells comprises each battery cell of the plurality of battery cells with a difference between the state of charge of the respective battery cells and the highest state of charge of a battery cell of the battery exceeding a threshold difference.
14. The system of any of illustrative examples 11-13, wherein the battery pack is balanced at a state of charge between 20-80%.
15. The system of any of illustrative examples 11-14, wherein the instructions for balancing the second set of battery cells in the battery pack relative to the first set of battery cells in the battery pack comprise: discharging the first set of battery cells to a load; and contemporaneously with discharging the first set of battery cells to the load, charging the second set of battery cells using the first set of battery cells.
16. The system of any of illustrative examples 11-15, wherein the instructions for balancing the second set of battery cells in the battery pack relative to the first set of battery cells in the battery pack comprise differentially discharging the first set of battery cells and the second set of battery cells.
17. The system of illustrative example 16, wherein the instructions for differentially discharging the first set of battery cells and the second set of battery cells comprise: discharging the first set of battery cells to a first load (or at a first discharge rate); and contemporaneously with discharging the first set of battery cells to the first load, discharging each battery cell of the second set of battery cells to a second load that is different from the first load (or at a different discharge rate or the second load is the same as the first load but where the second set of battery cells are discharged at a different discharge rate), wherein differentially discharging the first and second sets of battery cells results in balancing the first and second set of battery cells (e.g., bringing the cells into closer SoC balance, optimizing the usage range of one subset of cells, visiting an specific state of charge for observability, etc.). In some variations of illustrative example 17, the first and second set of battery cells can optionally be charged at different rates.
18. The system of any of illustrative examples 11-17, wherein during performance of the instructions for balancing the second set of battery cells, the processor is further configured to: receive a second set of sensor data; estimate a second state of charge for each battery cell of the battery pack using the sensor data; and update an assigned set of battery cells for each battery cell of the battery pack based on the second state of charge.
19. The system of any of illustrative examples 11-18, wherein the instructions for balancing the second set of battery cells do not comprise resting the first and second sets of battery cells.
20. The system of any of illustrative examples 11-19, wherein determining the state of charge comprises: processing the sensor measurements using a state estimator comprising on of: a Kalman filter, an unscented Kalman filter, an extended Kalman filter, a dual extended Kalman filter, a Schmidt-Kalman filter, a Gaussian process, or a particle filter; wherein the state estimator uses one or more model selected from: battery pack geometry model, sensor model, electrical components model, thermal transport model, battery cell heat generation model, battery cell heat transport model, equivalent circuit model, or a battery cell electrochemical model; wherein the model a parameterized model, wherein the parameterized model is parameterized as a function of one or more of: temperature, current, voltage, resistance, state of charge, battery age, time, or combinations thereof.

All or portions of the method can be performed by one or more components of the system, using a computing system, using a database (e.g., a system database, a third-party database, etc.), by a user, and/or by any other suitable system. The computing system can include one or more: CPUs, GPUs, custom FPGA/ASICS, microprocessors, servers, cloud computing, and/or any other suitable components. The computing system can be local, remote, distributed, or otherwise arranged relative to any other system or module.

Different subsystems and/or modules discussed above can be operated and controlled by the same or different entities. In the latter variants, different subsystems can communicate via: APIs (e.g., using API requests and responses, API keys, etc.), requests, and/or other communication channels.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, and/or FPGA/ASIC. However, the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the preceding system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A method for balancing a battery pack comprising:
measuring sensor data associated with the battery pack;
estimating a state of charge for a plurality of battery cells of the battery pack using the sensor data;
when a state of charge threshold is met, determining a first set of battery cells in the battery pack and a second set of battery cells in the battery pack, wherein each battery cell of the battery pack is in at most one of the first set or the second set; and
balancing the second set of battery cells in the battery pack relative to the first set of battery cells in the battery pack.

2. The method of claim 1, wherein each battery cell is assigned to the first set of battery cells or the second set of battery cells based on the state of charge for the respective battery cell.

3. The method of claim 1, wherein the state of charge threshold is a threshold variation across all of the estimated state of charge for each battery cell.

4. The method of claim 1, wherein the state of charge threshold is a threshold difference between a highest state of charge and a lowest state of charge of the estimated state of charges for each battery cells.

5. The method of claim 4, wherein the battery pack is balanced at a state of charge between 20-80%.

6. The method of claim 1, wherein balancing the second set of battery cells in the battery pack relative to the first set of battery cells in the battery pack comprises:
discharging the first set of battery cells to a load; and
contemporaneously with discharging the first set of battery cells to the load, charging the second set of battery cells using the first set of battery cells.

7. The method of claim 1, wherein balancing the second set of battery cells in the battery pack relative to the first set of battery cells in the battery pack comprises:
discharging the first set of battery cells and the second set of battery cells to a load; and
contemporaneously with discharging the first set of battery cells and the second set of battery cells to the load, discharging each battery cell of the first set of battery cells using a separate bleed resistor.

8. The method of claim 1, further comprising contemporaneously with balancing the second set of battery cells in the battery pack relative to the first set of battery cells in the battery pack:
measuring a second set of sensor data;
estimating a second state of charge for each battery cell of the battery pack using the sensor data; and
when the state of charge threshold is no longer met, halting balancing the second set of battery cells.

9. The method of claim 1, wherein balancing the second set of battery cells does not comprise resting the first and second sets of battery cells.

10. The method of claim 1, wherein determining the state of charge comprises: processing the sensor measurements using a state estimator comprising on of: a Kalman filter, an unscented Kalman filter, an extended Kalman filter, a dual extended Kalman filter, a Schmidt-Kalman filter, a Gaussian process, or a particle filter; wherein the state estimator uses one or more model selected from: battery pack geometry model, sensor model, electrical components model, thermal transport model, battery cell heat generation model, battery cell heat transport model, equivalent circuit model, or a battery cell electrochemical model; wherein the model a parameterized model, wherein the parameterized model is parameterized as a function of one or more of: temperature, current, voltage, resistance, state of charge, battery age, time, or combinations thereof.

11. A system comprising:
a battery pack comprising a plurality of battery cells:
a sensor connected to the battery pack and configured to measure sensor data associated with the battery pack; and
a processor in communication with the sensor wherein the processor is configured to:
receive the sensor data associated with the battery pack;
estimate a state of charge for each battery cell of the battery pack using the sensor data;
for each battery cell of the battery pack:
determine whether the respective battery cell is a member of a first set of battery cells in the battery pack or a second set of battery cells in the battery pack based on the state of charge of the respective battery cell, wherein each battery cell of the battery pack is in only one of the first set of battery cells or the second set of battery cells; and
provide instructions for balancing the second set of battery cells in the battery pack relative to the first set of battery cells in the battery pack.

12. The system of claim 11, wherein the processor is configured to determine whether to determine whether a respective battery cell is a member of the first set of battery cells in the battery pack or the second set of battery cells in the battery pack when a variation across all of the state of charges for each battery cell exceeds a threshold variation.

13. The system of claim 11, wherein the second set of battery cells comprises each battery cell of the plurality of battery cells with a difference between the state of charge of the respective battery cells and the highest state of charge of a battery cell of the battery exceeding a threshold difference.

14. The system of claim 13, wherein the highest state of charge is at most 80% when balancing the second set of battery cells relative to the first set of battery cells.

15. The system of claim 11, wherein the instructions for balancing the second set of battery cells in the battery pack relative to the first set of battery cells in the battery pack comprise:
discharging the first set of battery cells to a load; and
contemporaneously with discharging the first set of battery cells to the load, charging the second set of battery cells using the first set of battery cells.

16. The system of claim 11, wherein the instructions for balancing the second set of battery cells in the battery pack relative to the first set of battery cells in the battery pack comprise differentially discharging the first set of battery cells and the second set of battery cells.

17. The system of claim 16, wherein the instructions for differentially discharging the first set of battery cells and the second set of battery cells comprise:
discharging the first set of battery cells to a first load; and
contemporaneously with discharging the first set of battery cells to the first load, discharging the second set of battery cells to a second load that is different from the first load, wherein differentially discharging the first and second sets of battery cells results in balancing the first and second set of battery cells.

18. The system of claim 11, wherein during performance of the instructions for balancing the second set of battery cells, the processor is further configured to:
receive a second set of sensor data;
estimate a second state of charge for each battery cell of the battery pack using the sensor data; and
update an assigned set of battery cells for each battery cell of the battery pack based on the second state of charge.

19. The system of claim 11, wherein the instructions for balancing the second set of battery cells do not comprise resting the first and second sets of battery cells.

20. The system of claim 11, wherein determining the state of charge comprises: processing the sensor measurements using a state estimator comprising on of: a Kalman filter, an unscented Kalman filter, an extended Kalman filter, a dual extended Kalman filter, a Schmidt-Kalman filter, a Gaussian process, or a particle filter; wherein the state estimator uses one or more model selected from: battery pack geometry model, sensor model, electrical components model, thermal transport model, battery cell heat generation model, battery cell heat transport model, equivalent circuit model, or a battery cell electrochemical model; wherein the model a parameterized model, wherein the parameterized model is parameterized as a function of one or more of: temperature, current, voltage, resistance, state of charge, battery age, time, or combinations thereof.
